(19) United States
(12) Patent Application Publication
(10) Pub. No.: US 2025/0377930 A1
(43) Pub. Date: Dec. 11, 2025

(54) COMPUTING ACCELERATION METHODS AND APPARATUSES

(71) Applicant: Alipay (Hangzhou) Information Technology Co., Ltd., Hangzhou (CN)

(72) Inventor: Yufei LU, Hangzhou (CN)

(21) Appl. No.: 19/177,508

(22) Filed: Apr. 12, 2025

(30) Foreign Application Priority Data
Apr. 16, 2024 (CN) 202410460205.1

(51) Int. Cl. G06F 9/48

(52) U.S. Cl. CPC G06F 9/485

(57) ABSTRACT

Embodiments of this specification provide a computing acceleration method and apparatus, and the method includes: determining a target interface corresponding to a target hardware accelerator card from a preset first tree-structured interface set, where the first tree-structured interface set includes a plurality of interfaces, and the plurality of interfaces are respectively corresponding to a plurality of computing functions; the plurality of interfaces include a root interface, a non-root interface other than the root interface in the plurality of interfaces uses another interface in the plurality of interfaces as a parent interface, and a computing function corresponding to each non-root interface is a sub-computing function obtained by decomposing a computing function corresponding to a parent interface of the non-root interface; and accessing the target hardware accelerator card through the target interface, where the target hardware accelerator card is configured to execute a target computing function corresponding to the target interface.

### TECHNICAL FIELD

One or more embodiments of this specification relate to the field of computing acceleration and privacy computing technologies, and in particular, to computing acceleration methods and apparatuses.

### BACKGROUND

Complex computing tasks often have high computing costs and often have low computing performance in conventional computing environments. For example, in a privacy computing task generally implemented based on a cryptography algorithm, computing performance thereof is often hundreds or even tens of thousands times slower than that of a conventional plaintext computing task. Consequently, it is difficult to use the privacy computing task in an actual production scenario. Therefore, in some computing solutions, computing acceleration is performed by using various types of hardware accelerator cards, so that computing performance of these complex computing tasks can meet a practical standard. However, specific computing functions or interfaces of hardware accelerator cards produced by different manufacturers are often different, and thus difficulty and costs of accessing and using these hardware accelerator cards for computing acceleration are high.

Therefore, to reduce difficulty and costs of accelerating computing by using a hardware accelerator card, a new computing acceleration method is required.

### SUMMARY

One or more embodiments of this specification describe a computing acceleration method and apparatus, which can significantly reduce difficulty for hardware accelerator card manufacturers to enable accelerator cards produced thereby to access a computing program or framework for accelerating computing. In addition, a range of hardware acceleration devices that can be accessed by the computing program or framework is greatly extended, to resolve a disadvantage of the prior art.

According to a first aspect, a computing acceleration method is provided, including:
determining a target interface corresponding to a target hardware accelerator card from a preset first tree-structured interface set, where the first tree-structured interface set includes a plurality of interfaces, and the plurality of interfaces are respectively corresponding to a plurality of computing functions; the plurality of interfaces include a root interface, a non-root interface other than the root interface in the plurality of interfaces uses another interface in the plurality of interfaces as a parent interface, and a computing function corresponding to each non-root interface is a subdivided computing function obtained by decomposing a computing function corresponding to a parent interface of the non-root interface; and
accessing the target hardware accelerator card through the target interface, where the target hardware accelerator card is configured to execute a target computing function corresponding to the target interface.

In a possible implementation, the method further includes:
sending a target computing task corresponding to the target computing function to the target hardware accelerator card, and receiving a computing result that is of the target computing task and returned by the target hardware accelerator card.

In a possible implementation, the method further includes:
before the target computing task corresponding to the target computing function is sent to the target hardware accelerator card, receiving a first computing task from a target computing program; and
if the first computing task corresponds to a computing function corresponding to the root interface, using the first computing task as the target computing task; or if the first computing task corresponds to a computing function corresponding to the non-root interface, decomposing the first computing task to obtain the target computing task.

In a possible implementation, decomposing the first computing task to obtain the target computing task includes: decomposing the first computing task to obtain the target computing task and another computing part, where the another computing part is executed by using a software computing module and/or another hardware accelerator card.

In a possible implementation, the first tree-structured interface set is disposed in a predetermined computing framework, and the target application program is an internal application program or an external application program of the computing framework.

In a possible implementation, determining the target interface corresponding to the target hardware accelerator card from the preset first tree-structured interface set includes:
determining a first tree-structured interface set from a plurality of preset tree-structured interface sets, where the target computing function is a computing function corresponding to a root interface in the first tree-structured interface set, or a subdivided computing function obtained by decomposing the computing function corresponding to the root interface; and
determining the target interface from the first tree-structured interface set.

In a possible implementation, one or more of the plurality of computing functions are used for privacy computing.

In a possible implementation, the target hardware accelerator card includes one of a graphics processing unit GPU, a field programmable gate array FPGA, and an application-specific integrated circuit ASIC.

According to a second aspect, a computing acceleration apparatus is provided, where the apparatus includes:
a determining unit, configured to determine a target interface corresponding to a target hardware accelerator card from a preset first tree-structured interface set, where the first tree-structured interface set includes a plurality of interfaces, and the plurality of interfaces are respectively corresponding to a plurality of computing functions; the plurality of interfaces include a root interface, a non-root interface other than the root interface in the plurality of interfaces uses another interface in the plurality of interfaces as a parent interface, and a computing function corresponding to each non-root interface is a subdivided computing function obtained by decomposing a computing function corresponding to a parent interface of the non-root interface; and
an access unit, configured to access the target hardware accelerator card through the target interface, where the target hardware accelerator card is configured to accelerate a target computing function corresponding to the target interface.

According to a fourth aspect, a computing device is provided, and includes a storage and a processor. The storage stores executable code. When the processor executes the executable code, the method according to the first aspect is implemented. One or more of the method, the apparatus, the computing device, or the storage medium in the foregoing aspects may be used to significantly reduce difficulty for hardware accelerator card manufacturers to enable accelerator cards produced thereby to access a computing program or framework for accelerating computing. In addition, a range of hardware acceleration devices that can be accessed by the computing program or framework is greatly extended.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram illustrating a computing acceleration solution;

FIG. 2 is a schematic diagram illustrating a computing acceleration method, according to an embodiment of this specification;

FIG. 3 is a flowchart illustrating a computing acceleration method, according to an embodiment of this specification;

FIG. 4 is a schematic diagram illustrating a computing acceleration method, according to another embodiment of this specification;

FIG. 5 is a schematic diagram illustrating an internal invoking interface of a computing framework, according to an embodiment of the specification;

FIG. 6 is a schematic diagram illustrating an external invoking interface of a computing frame, according to an embodiment of this specification; and

FIG. 7 is a structural diagram illustrating a computing acceleration apparatus, according to an embodiment of this specification.

### DESCRIPTION OF EMBODIMENTS

The solutions provided in this specification are described below with reference to the accompanying drawings.

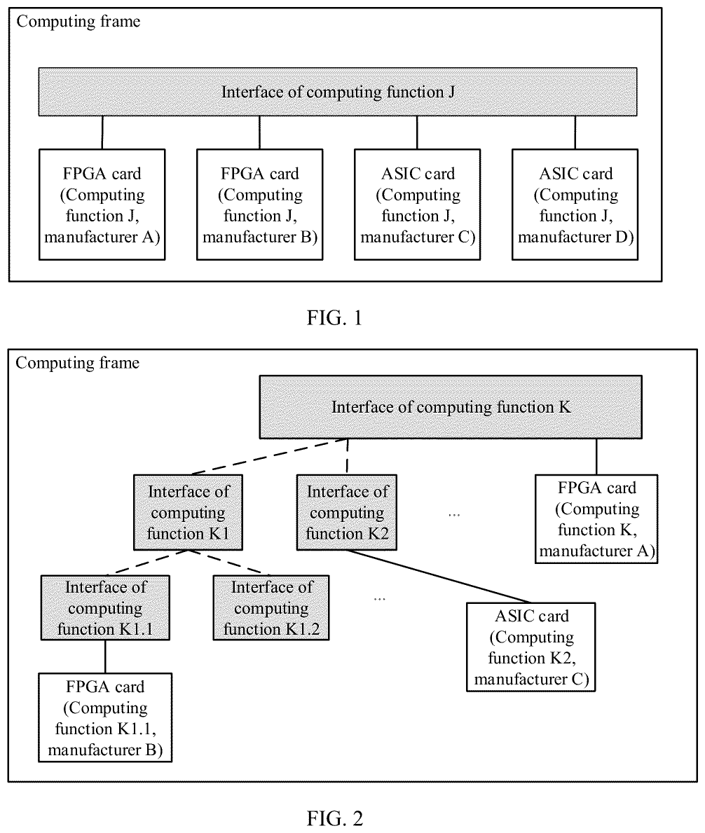

As mentioned earlier, complex computing tasks often have high computing costs and often have low performance in conventional computing environments. For example, in a privacy computing task generally implemented based on a cryptography algorithm, computing performance thereof is often hundreds or even tens of thousands times slower than that of a conventional plaintext computing task. Consequently, it is difficult to use the privacy computing task in an actual production scenario. Therefore, in some computing solutions, computing acceleration is performed by using various types of hardware accelerator cards, so that computing performance of these complex computing tasks can meet a practical standard. However, specific computing functions or interfaces of hardware accelerator cards produced by different manufacturers are often different, and thus difficulty and costs of accessing and using these hardware accelerator cards for computing acceleration are high. FIG. 1 is a schematic diagram illustrating a computing acceleration solution. As shown in FIG. 1, for example, a specific computing framework or a computing program hopes to access a hardware accelerator card implementing a specific computing function J (which may be, for example, a fully homomorphic encryption (FHE) computing function). Through FHE, computing may be directly performed in a ciphertext, and a result thereof is consistent with that of a plaintext. Due to this computing characteristic, FHE is widely used in various types of privacy protection computing. However, computing with FHE is often more than 10,000 times slower than that of plaintext computing, and hardware acceleration is often required to enable FHE to be practical in a production scenario. According to the solution shown in FIG. 1, different manufacturers (for example, manufacturer A, manufacturer B, manufacturer C, and manufacturer D) need to implement complete computing functions of complete FHE (for example, encryption computing, decryption computing, ciphertext addition computing, ciphertext multiplication computing, and the like) based on different types of produced hardware accelerator cards (for example, FPGA cards and ASIC cards). However, although a manufacturer of a hardware accelerator card is good at producing hardware, the manufacturer is often not good at algorithm implementation, especially for a very complex computing function such as FHE. Therefore, it is very difficult for a hardware manufacturer to implement complete computing functions of FHE by using a hardware accelerator card thereof. Consequently, it is difficult for a specific computing framework or a computing program to accelerate FHE computing by accessing different hardware accelerator cards.

To resolve the foregoing technical problem, an embodiment of this specification provides a computing acceleration method. A core idea is as follows: First, a target interface corresponding to a computing function that can be implemented by a target hardware accelerator card may be determined from a preset tree-structured interface set. The tree-structured interface set includes a plurality of interfaces. The plurality of interfaces include a root interface, and a non-root interface other than the root interface uses another interface in the plurality of interfaces as a parent interface. The root interface corresponds to a specific computing function, and a computing function corresponding to a non-root interface is a subdivided computing function obtained by decomposing a computing function corresponding to a parent interface thereof. Then, the target hardware accelerator card may be accessed through the target interface. In different embodiments, computing functions corresponding to the root interface in the preset tree-structured interface set may be different. FIG. 2 is a schematic diagram illustrating a computing acceleration method, according to an embodiment of this specification. As shown in FIG. 2, for example, a root interface in a preset tree-structured interface set is corresponding to a computing function K. By decomposing the computing function K, for example, a computing function K1, a computing function K2, and . . . may be obtained. Therefore, in the tree-structured interface set, the root interface may have a lower-layer interface (or referred to as a sub-interface), that is, an interface corresponding to the computing function K1, an interface corresponding to the computing function K2, and. . . . By decomposing the computing function K1, for example, a computing function K1.1, a computing function K1.2, and . . . may be obtained, and the interface corresponding to the computing function K1 may have a lower-layer interface, that is, an interface corresponding to the computing function K1.1 and an interface corresponding to the computing function K1.2. For example, manufacturer A produces an FPGA card that implements the computing function K, so that the FPGA card can be accessed through the root interface in the tree-structured interface set, and further, the computing function K can be directly executed by using the FPGA card, so as to accelerate the computing function K. For another example, if manufacturer C produces an ASIC card that implements the computing function K2, the ASIC card can be accessed through a sub-interface of the root interface in the tree-structured interface set, that is, the interface corresponding to the computing function K2. Further, the computing function K2 may be executed by using the ASIC card, so as to accelerate the computing function K2. Because the computing function K2 is essentially a subdivided computing function of the computing function K, the acceleration computing function K2 may also produce a partial acceleration effect on the computing function K. For another example, if manufacturer B produces an FPGA card that implements the computing function K1.1, the FPGA card can be accessed through the interface corresponding to the computing function K1.1 in the tree-structured interface set. Further, the computing function K1.1 may be executed by using the FPGA card, so as to accelerate the computing function K1.1. The computing function K1.1 is a subdivided computing function of the computing function K1, that is, is obtained by subdividing the computing function K1, and the computing function K1 is obtained by dividing the computing function K. The computing function K1.1 may alternatively be essentially obtained by subdividing the computing function K, that is, a subdivided computing function of K. Accelerating the computing function K1.1 can also produce an acceleration effect on the computing function K.

The method has the following advantages: First, difficulty for hardware accelerator card manufacturers to enable accelerator cards produced thereby to access a computing program or framework for accelerating computing is significantly reduced. Different hardware accelerator card manufacturers may gain access through corresponding interfaces in the tree-structured interface set according to computing capabilities actually implemented by accelerator cards produced thereby. For example, for a specific computing function, accelerator cards produced by different hardware accelerator card manufacturers do not need to implement complete computing functions. Implementing only a part of the functions can also have an acceleration effect on the computing function after the accelerator cards are accessed. Second, a range of hardware acceleration devices that can be accessed by a computing program or framework is greatly extended. For a specific computing function, not only all computing functions of the specific computing function can be implemented, but also a hardware accelerator card that is produced by a hardware accelerator card manufacturer and that implements a part of the functions can be used for accelerating computing for the specific computing function. Third, in some embodiments, for a specific computing function, a part that cannot be executed by accessing the hardware accelerator card may be executed by using a software module. Therefore, complete computing functions can be provided with fully utilizing hardware acceleration capabilities of different types of accessible hardware accelerator cards.

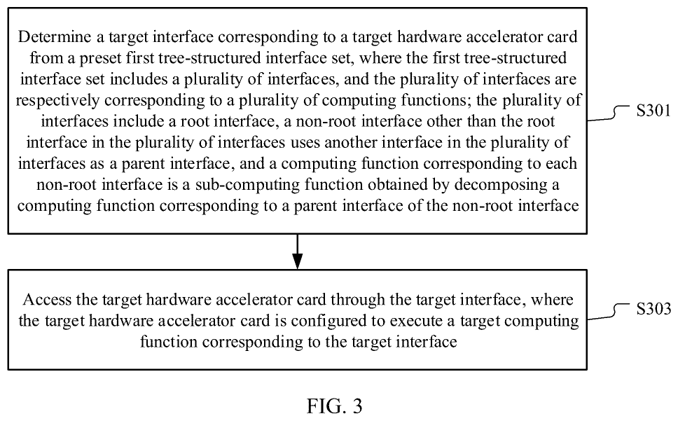

The following describes in detail a computing acceleration method provided in an embodiment of this specification. FIG. 3 is a flowchart illustrating a computing acceleration method, according to an embodiment of this specification. As shown in FIG. 3, the method includes at least the following steps.

Step S301: Determine a target interface corresponding to a target hardware accelerator card from a preset first tree-structured interface set, where the first tree-structured interface set includes a plurality of interfaces, and the plurality of interfaces are respectively corresponding to a plurality of computing functions; the plurality of interfaces include a root interface, a non-root interface other than the root interface in the plurality of interfaces uses another interface in the plurality of interfaces as a parent interface, and a computing function corresponding to each non-root interface is a sub-computing function obtained by decomposing a computing function corresponding to a parent interface of the non-root interface.

Step S303: Access the target hardware accelerator card through the target interface, where the target hardware accelerator card is configured to execute a target computing function corresponding to the target interface.

First, in step S301, the target interface corresponding to the target hardware accelerator card is determined from the preset first tree-structured interface set, where the first tree-structured interface set includes a plurality of interfaces, and the plurality of interfaces are respectively corresponding to a plurality of computing functions. In this step, the plurality of interfaces may include a root interface. A non-root interface other than the root interface in the plurality of interfaces uses another interface in the plurality of interfaces as a parent interface. A computing function corresponding to each non-root interface is a sub-computing function obtained by decomposing a computing function corresponding to a parent interface of the non-root interface. In different embodiments, computing functions corresponding to the root interface in the first tree-structured interface set may be different, which is not limited in this specification.

Because the tree-structured interface set is essentially a hierarchical interface set, a computing function corresponding to an interface at each layer below the root interface is essentially a further division of a computing function corresponding to a parent interface at an upper layer. That is, computing functions corresponding to all non-root interfaces are essentially obtained through direct or step-by-step division from the computing function corresponding to the root interface. In different embodiments, specific manners of decomposing the computing function corresponding to the root interface to obtain the computing function corresponding to the non-root interface may be different, and this is not limited in this specification. In an embodiment, one or more of the plurality of computing functions are used for privacy computing.

In different embodiments, specific types of the target hardware accelerator card may be different. In an embodiment, the target hardware accelerator card may include one of a graphics processing unit (GPU), a field programmable gate array (FPGA), and an application-specific integrated circuit (ASIC).

In different embodiments, specific manners of determining the target interface from the first tree-structured interface set may be different. In an embodiment, a first tree-structured interface set may be determined from a plurality of preset tree-structured interface sets, and the target computing function is a computing function corresponding to a root interface in the first tree-structured interface set or a sub-computing function obtained by decomposing the computing function corresponding to the root interface; and the target interface is determined from the first tree-structured interface set. For example, in a specific embodiment, for example, the target computing function is a sub-computing function K1 obtained by decomposing a computing function K. A plurality of root interfaces of a plurality of tree-structured interface sets are respectively corresponding to a computing function J, a computing function K, a computing function M, and a computing function N. Then, a tree-structured interface set whose root interface is corresponding to the computing function K may be determined from the plurality of tree-structured interface sets, and an interface corresponding to the sub-computing function K1 is confirmed from the tree-structured interface set.

After the target interface is determined, in step S403, the target hardware accelerator card may be accessed through the target interface. In this step, the target hardware accelerator card may be configured to execute the target computing function corresponding to the target interface. The target computing function may be a subdivided computing function obtained by decomposing a root computing function of the first tree-structured interface set (that is, the computing function corresponding to the root interface of the first tree-structured interface set). In different embodiments, the target computing function may be different specific computing functions. In different embodiments, specific manners of accessing the target hardware accelerator card through the target interface may be different. In an embodiment, the target hardware accelerator card may be accessed through the target interface according to a parameter of the target computing function and a type of the target hardware accelerator card.

As described above, the target hardware accelerator card may be configured to execute the target computing function corresponding to the target interface. Therefore, in an embodiment, after step 303, the target computing task corresponding to the target computing function may further be sent to the target hardware accelerator card, and a computing result that is of the target computing task and returned by the target hardware accelerator card may be received.

In different embodiments, the target computing task may be a computing task from an application program, or may be obtained by decomposing the computing task from the application program. Therefore, in an embodiment, before the target computing task corresponding to the target computing function is sent to the target hardware accelerator card, a first computing task may be received from the target computing program; if the first computing task corresponds to a computing function corresponding to the root interface, the first computing task is used as the target computing task; or if the first computing task corresponds to a computing function corresponding to the non-root interface, the first computing task is decomposed to obtain the target computing task. In different embodiments, specific manners of decomposing the first computing task may be different according to different computing functions corresponding to the root interface, which is not limited in this specification.

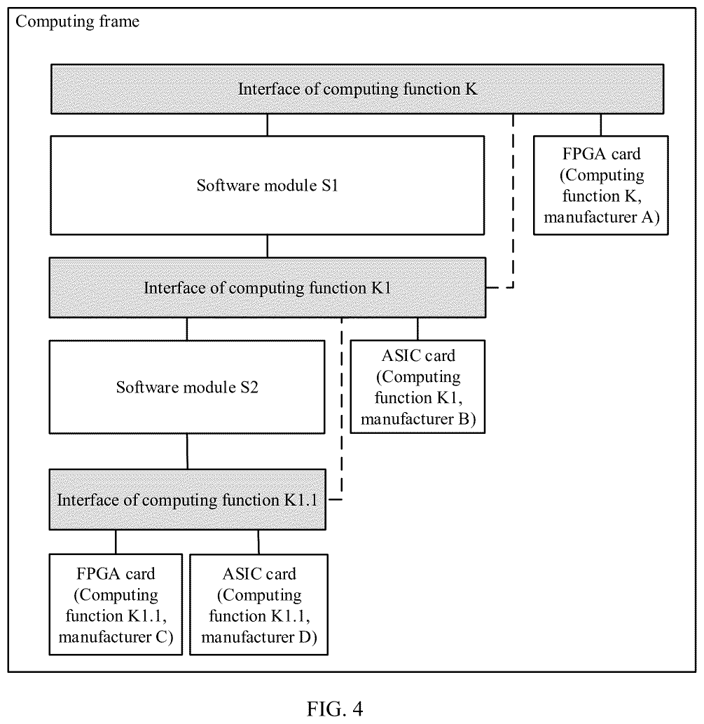

In a case in which the target computing task is obtained by decomposing a computing task from an application program, to complete a complete first computing task, for example, from the application program, a part of the first computing task other than the target computing task may be completed by using a software module or another hardware accelerator card. In a specific embodiment, the first computing task from the target computing program may be decomposed to obtain the target computing task and another computing part. The another computing part is executed by using a software computing module and/or another hardware accelerator card. FIG. 4 is a schematic diagram illustrating a computing acceleration method, according to another embodiment of this specification. As shown in FIG. 4, for example, a computing task (for example, a task k) corresponding to an interface of a computing function K may be executed by an FPGA card that accesses the interface of the computing function K, that is produced by, for example, manufacturer A, and that has the computing function K. In another example, a task 1 may also be executed by using a software module S1 and an ASIC card that accesses the interface of the computing function K1, that is produced by, for example, manufacturer A, and that has the computing function K1, where the ASIC card executes a subtask k1 corresponding to the computing function K1 in the task k, and S1 is configured to execute another computing part other than the subtask k1 in the task k. In still another example, the task 1 may also be executed by using the software module S1, a software module S2, and an FPGA card that accesses an interface of a computing function K1.1, that is produced by, for example, manufacturer C, and that has the computing function K1.1 (by decomposing the computing function K1), where the ASIC card executes a subtask k1.1 corresponding to the computing function K1.1 in the task k1, S1 is configured to execute another computing part other than the subtask k1 in the task k, and S2 is configured to execute another computing part other than the subtask k1.1 in the task k1. Similarly, in an example, the task 1 may also be executed by using the software module S1, the software module S2, and an ASIC card that accesses the interface of the computing function K1.1, that is produced by, for example, manufacturer D, and that has the computing function K1.1.

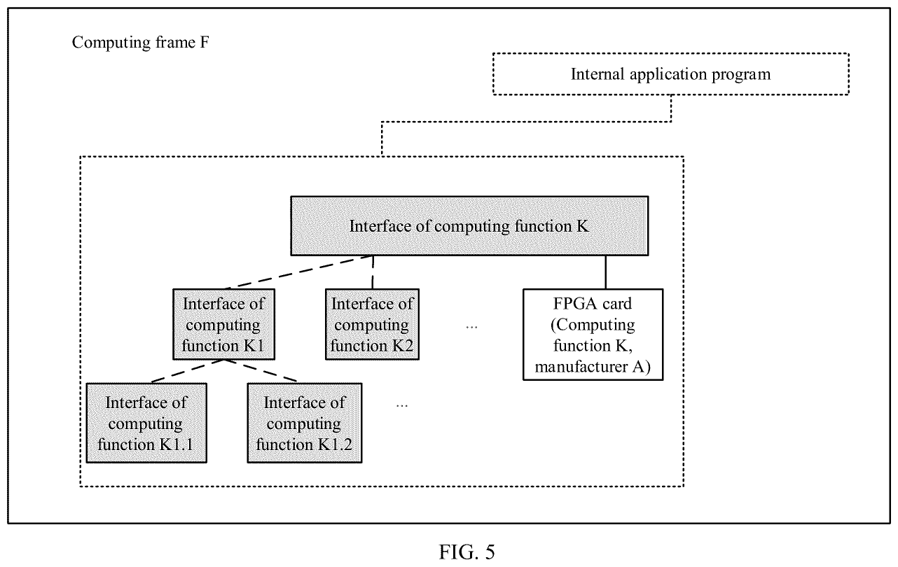

A computing framework refers to a computing engine designed to simplify or facilitate a computing process and enhance efficiency, featuring standardization, modularity, and high-concurrency support. In an embodiment, the first tree-structured interface set may be disposed in a predetermined computing framework, and the target application program may be an internal application program or an external application program of the computing framework. In different embodiments, a predetermined computing framework may be a different specific computing framework, which is not limited in this specification. In a specific embodiment, for example, the predetermined computing framework may be a privacy computing framework. FIG. 5 is a schematic diagram illustrating an internal invoking interface of a computing framework, according to an embodiment of the specification. As shown in FIG. 5, an interface set (for example, a first tree-structured interface set) corresponding to a computing function K and a subdivided computing function of the computing function K may be, for example, deployed in a computing apparatus in a computing frame F. The computing apparatus may receive a computing task, such as a computing task corresponding to the computing function K, sent by an internal program of the computing frame F. A hardware accelerator card that accesses the first tree-structured interface set executes a computing task corresponding to the computing function K or the subdivided computing function of the computing function K.

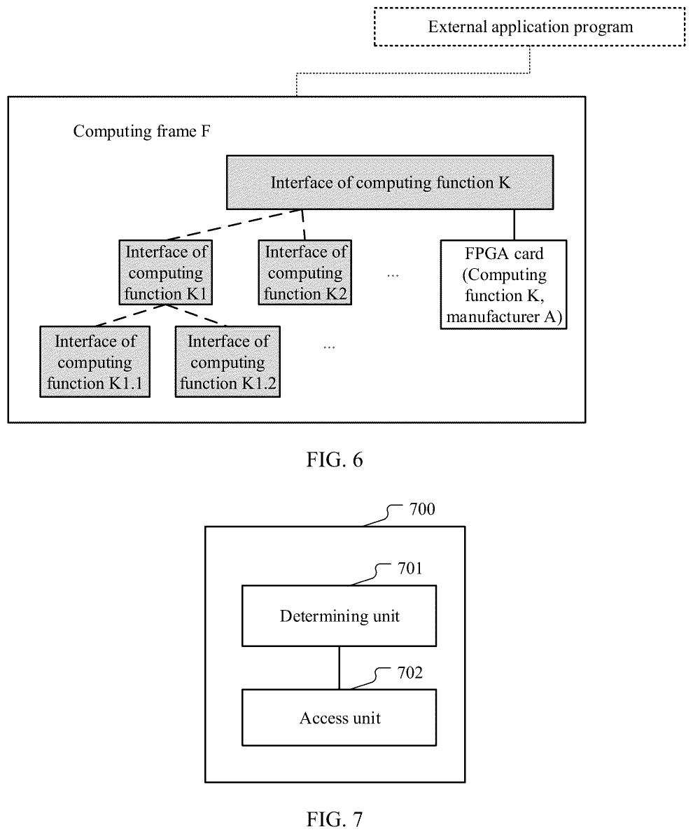

FIG. 6 is a schematic diagram illustrating an external invoking interface of a computing frame, according to an embodiment of this specification. As shown in FIG. 6, in another example, an interface set (for example, a first tree-structured interface set) corresponding to a computing function K and a subdivided computing function of the computing function K may be, for example, deployed in a computing frame F. The computing frame F may receive a computing task, such as a computing task corresponding to the computing function K, sent by an external program of the computing frame F. A hardware accelerator card that accesses the first tree-structured interface set executes a computing task corresponding to the computing function K or the subdivided computing function of the computing function K.

In another aspect, corresponding to the foregoing method process, an embodiment of the specification further discloses a computing acceleration apparatus. FIG. 7 is a structural diagram illustrating a computing acceleration apparatus, according to an embodiment of this specification. As shown in FIG. 7, the apparatus 700 includes:
a determining unit 701, configured to determine a target interface corresponding to a target hardware accelerator card from a preset first tree-structured interface set, where the first tree-structured interface set includes a plurality of interfaces, and the plurality of interfaces are respectively corresponding to a plurality of computing functions; the plurality of interfaces include a root interface, a non-root interface other than the root interface in the plurality of interfaces uses another interface in the plurality of interfaces as a parent interface, and a computing function corresponding to each non-root interface is a sub-computing function obtained by decomposing a computing function corresponding to a parent interface of the non-root interface; and
an access unit 702, configured to access the target hardware accelerator card through the target interface, where the target hardware accelerator card is configured to accelerate a target computing function corresponding to the target interface.

According to still another aspect of an embodiment of this specification, a computer-readable storage medium is provided. The computer-readable storage medium stores a computer program. When the computer program is executed in a computer, the computer is enabled to perform any one of the above-mentioned methods.

According to yet another aspect of an embodiment of this specification, a computing device is provided, and includes a storage and a processor. The storage stores executable code. When the processor executes the executable code, any one of the above-mentioned methods is implemented.

It should be understood that descriptions such as “first” and “second” in this specification are merely intended to distinguish between similar concepts for ease of description, and do not impose a limitation.

Although the one or more embodiments of this specification provide the operation steps of the method according to an embodiment or a flowchart, the conventional or non-creative means can include more or fewer operation steps. A sequence of the steps listed in the embodiment is merely one of numerous execution sequences of the steps, and does not represent a unique execution sequence. In actual execution of an apparatus or a terminal product, execution can be performed based on a method sequence shown in the embodiments or the accompanying drawings, or performed in parallel (for example, a parallel processor or a multi-thread processing environment, or even a distributed data processing environment). Terms “include”, “contain”, or their any other variant is intended to cover non-exclusive inclusion, so a process, a method, an article, or a device that includes a series of elements not only includes these very elements, but also includes other elements which are not expressly listed, or further includes elements inherent to such process, method, article, or device. Without more constraints, it is not excluded that the process, method, product, or device including the described elements can also include additional identical or equivalent elements.

For ease of description, the above-mentioned apparatus is described by dividing the apparatus into various modules based on functions. Certainly, when the one or more embodiments of this specification are implemented, the functions of each module can be implemented in one or more pieces of software and/or hardware, or a module implementing a same function can be implemented by a combination of a plurality of submodules or subunits. The described apparatus embodiment is merely an example. For example, the unit division is merely logical function division and can be other division in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

A person skilled in the art should be aware of that one or more embodiments of this specification can be provided as a method, system, or computer program product. Therefore, one or more embodiments of this specification can use a form of hardware only embodiments, software only embodiments, or embodiments with a combination of software and hardware. In addition, one or more embodiments of this specification can use a form of a computer program product that is implemented on one or more computer-usable storage media (including but not limited to a disk memory, a CD-ROM, an optical memory, etc.) that include computer-usable program code.

One or more embodiments of this specification can be described in the general context of computer-executable instructions, for example, a program module. Usually, the program module includes a routine, a program, an object, a component, a data structure, etc. executing a specific task or implementing a specific abstract data type. Or one or more embodiments of this specification can be practiced in distributed computing environments. In the distributed computing environments, tasks are performed by remote processing devices connected through a communication network. In the distributed computing environments, program modules can be located in local and remote computer storage media including storage devices.

The embodiments of this specification are described in a progressive way. For same or similar parts in the embodiments, refer to each other. Each embodiment focuses on a difference from the other embodiments. Particularly, the system embodiments are basically similar to the method embodiments, and therefore are described briefly. For related parts, references can be made to some descriptions in the method embodiments. In the descriptions of this specification, reference to the descriptions of the terms “one embodiment”, “some embodiments”, “example”, “specific example”, or “some examples” means that specific features, structures, materials, or characteristics described in the embodiments or examples are included in at least one embodiment or example of this specification. In this specification, example descriptions of the above-mentioned terms do not need to be specific to the same embodiment or example. In addition, the described specific features, structures, materials, or characteristics can be combined in a proper way in any one or more embodiments or examples. In addition, a person skilled in the art can integrate or combine different embodiments or examples and characteristics of different embodiments or examples described in this specification, provided that they do not conflict with each other.

The previous descriptions are merely embodiments of the one or more embodiments of this specification, and are not intended to limit the one or more embodiments of this specification. For a person skilled in the art, the one or more embodiments of this specification can have various modifications and changes. Any modification, equivalent replacement, or improvement made without departing from the spirit and principle of this specification shall fall within the scope of the claims.

1. A computing acceleration method, comprising:
determining a target interface corresponding to a target hardware accelerator card from a preset first tree-structured interface set, wherein the first tree-structured interface set comprises a plurality of interfaces, and the plurality of interfaces are respectively corresponding to a plurality of computing functions; the plurality of interfaces comprise a root interface, a non-root interface other than the root interface in the plurality of interfaces uses another interface in the plurality of interfaces as a parent interface, and a computing function corresponding to each non-root interface is a subdivided computing function obtained by decomposing a computing function corresponding to a parent interface of the non-root interface; and
accessing the target hardware accelerator card through the target interface, wherein the target hardware accelerator card is configured to execute a target computing function corresponding to the target interface.

2. The method according to claim 1, further comprising:
sending a target computing task corresponding to the target computing function to the target hardware accelerator card, and receiving a computing result that is of the target computing task and returned by the target hardware accelerator card.

3. The method according to claim 2, further comprising:
before the target computing task corresponding to the target computing function is sent to the target hardware accelerator card, receiving a first computing task from a target computing program; and
if the first computing task corresponds to a computing function corresponding to the root interface, using the first computing task as the target computing task; or if the first computing task corresponds to a computing function corresponding to the non-root interface, decomposing the first computing task to obtain the target computing task.

4. The method according to claim 3, wherein decomposing the first computing task to obtain the target computing task comprises: decomposing the first computing task to obtain the target computing task and another computing part, wherein the another computing part is executed by using a software computing module and/or another hardware accelerator card.

5. The method according to claim 3, wherein the first tree-structured interface set is disposed in a predetermined computing framework, and the target application program is an internal application program or an external application program of the computing framework.

6. The method according to claim 1, wherein determining the target interface corresponding to the target hardware accelerator card from the preset first tree-structured interface set comprises:
determining a first tree-structured interface set from a plurality of preset tree-structured interface sets, wherein the target computing function is a computing function corresponding to a root interface in the first tree-structured interface set, or a subdivided computing function obtained by decomposing the computing function corresponding to the root interface; and
determining the target interface from the first tree-structured interface set.

7. The method according to claim 1, wherein one or more of the plurality of computing functions are used for privacy computing.

8. The method according to claim 1, wherein the target hardware accelerator card comprises one of a graphics processing unit GPU, a field programmable gate array FPGA, and an application-specific integrated circuit ASIC.

9. (canceled)

10. A non-transitory computer-readable storage medium, wherein the non-transitory computer-readable storage medium stores a computer program, which when executed on a computer causes the computer to:
determine a target interface corresponding to a target hardware accelerator card from a preset first tree-structured interface set, wherein the first tree-structured interface set comprises a plurality of interfaces, and the plurality of interfaces are respectively corresponding to a plurality of computing functions; the plurality of interfaces comprise a root interface, a non-root interface other than the root interface in the plurality of interfaces uses another interface in the plurality of interfaces as a parent interface, and a computing function corresponding to each non-root interface is a subdivided computing function obtained by decomposing a computing function corresponding to a parent interface of the non-root interface; and
access the target hardware accelerator card through the target interface, wherein the target hardware accelerator card is configured to execute a target computing function corresponding to the target interface.

11. A computing device, comprising a memory and a processor, wherein the memory stores executable code, which when executed by a processor causes the processor to:
determine a target interface corresponding to a target hardware accelerator card from a preset first tree-structured interface set, wherein the first tree-structured interface set comprises a plurality of interfaces, and the plurality of interfaces are respectively corresponding to a plurality of computing functions; the plurality of interfaces comprise a root interface, a non-root interface other than the root interface in the plurality of interfaces uses another interface in the plurality of interfaces as a parent interface, and a computing function corresponding to each non-root interface is a subdivided computing function obtained by decomposing a computing function corresponding to a parent interface of the non-root interface; and
access the target hardware accelerator card through the target interface, wherein the target hardware accelerator card is configured to execute a target computing function corresponding to the target interface.

12. The non-transitory computer-readable storage medium according to claim 10, wherein the computer further comprises being caused to:
send a target computing task corresponding to the target computing function to the target hardware accelerator card, and receive a computing result that is of the target computing task and returned by the target hardware accelerator card.

13. The non-transitory computer-readable storage medium according to claim 12, wherein the computer further comprises being caused to:
before the target computing task corresponding to the target computing function is sent to the target hardware accelerator card, receive a first computing task from a target computing program; and
if the first computing task corresponds to a computing function corresponding to the root interface, use the first computing task as the target computing task; or if the first computing task corresponds to a computing function corresponding to the non-root interface, decompose the first computing task to obtain the target computing task.

14. The non-transitory computer-readable storage medium according to claim 13, wherein the computer being caused to decompose the first computing task to obtain the target computing task comprises being caused to: decompose the first computing task to obtain the target computing task and another computing part, wherein the another computing part is executed by using a software computing module and/or another hardware accelerator card.

15. The non-transitory computer-readable storage medium according to claim 13, wherein the first tree-structured interface set is disposed in a predetermined computing framework, and the target application program is an internal application program or an external application program of the computing framework.

16. The non-transitory computer-readable storage medium according to claim 10, wherein the computer being caused to determine the target interface corresponding to the target hardware accelerator card from the preset first tree-structured interface set comprises being caused to:
determine a first tree-structured interface set from a plurality of preset tree-structured interface sets, wherein the target computing function is a computing function corresponding to a root interface in the first tree-structured interface set, or a subdivided computing function obtained by decomposing the computing function corresponding to the root interface; and
determine the target interface from the first tree-structured interface set.

17. The computing device according to claim 11, wherein the processor further comprises being caused to:
send a target computing task corresponding to the target computing function to the target hardware accelerator card, and receive a computing result that is of the target computing task and returned by the target hardware accelerator card.

18. The computing device according to claim 17, wherein the processor further comprises being caused to:
before the target computing task corresponding to the target computing function is sent to the target hardware accelerator card, receive a first computing task from a target computing program; and
if the first computing task corresponds to a computing function corresponding to the root interface, use the first computing task as the target computing task; or if the first computing task corresponds to a computing function corresponding to the non-root interface, decompose the first computing task to obtain the target computing task.

19. The computing device according to claim 18, wherein the processor being caused to decompose the first computing task to obtain the target computing task comprises being caused to: decompose the first computing task to obtain the target computing task and another computing part, wherein the another computing part is executed by using a software computing module and/or another hardware accelerator card.

20. The computing device according to claim 18, wherein the first tree-structured interface set is disposed in a predetermined computing framework, and the target application program is an internal application program or an external application program of the computing framework.

21. The computing device according to claim 11, wherein the processor being caused to determine the target interface corresponding to the target hardware accelerator card from the preset first tree-structured interface set comprises being caused to:
determine a first tree-structured interface set from a plurality of preset tree-structured interface sets, wherein the target computing function is a computing function corresponding to a root interface in the first tree-structured interface set, or a subdivided computing function obtained by decomposing the computing function corresponding to the root interface; and
determine the target interface from the first tree-structured interface set.
